(19) United States
(12) Patent Application Publication
(10) Pub. No.: US 2015/0363615 A1
(43) Pub. Date: Dec. 17, 2015

(54) Cellphone controlling a device with a wireless tag

(71) Applicant: Wesley John Boudville, Perth (AU)

(72) Inventor: Wesley John Boudville, Perth (AU)

(21) Appl. No.: 14/120,652

(22) Filed: Jun. 13, 2014

(51) Int. Cl. G06K 7/10

(52) U.S. Cl. CPC G06K 7/10366; G06K 7/10217

(57) ABSTRACT

A device has a tag. The device is connected to the Internet and runs a web server. The device controls sensors or machinery. The tag encodes an URL whose address is the device. A person scans the tag with a mobile device, like a phone. The phone queries the server. The page sent to the phone lets her control various aspects of the device. The device lets a maximum number of users actively control it at the same time. Extra users go into a queue with a maximum length. When the queue is full, if the tag is active, it is turned off. The device can have several tags or speakers distributed over different locations, where the speakers emit audio encoding an URL giving a similar control of the device. A tag can be reconfigured if the device changes its Internet address. Or the tag can be periodically reconfigured to favour giving control to users who are currently near it. The URL format can be used by the phone to decide not to make a wireless query to the server. Saves energy on the phone.

### REFERENCES CITED

“Reconfigurable RFID tag antenna for wireless temperature monitoring” by Z. Jiang, Antennas and Propagation Society International Symposium (2012), ISBN 978-1-4673-0461-0.
“An automated low power reconfigurable RFID tag” by A. K. Jones et al, Design Automation Conference 2006, ISBN 1-59593-381-6.
“System and Method for Performance Tracking for Motivating Individuals to Capture Consumer Data Via Mobile Devices” by A. Standoff et al, US patent application 20140108104 (Apr. 17, 2014).
“URI Service system and method” by J. Chor, US patent application 20130304855 (Nov. 14, 2013).
“Initiating schedule management via Near Field Communication” by F. Bargetzi et al, US patent application 20140074537 (Mar. 13, 2014).
“Dynamic group purchases using barcodes” by W. Boudville, U.S. Pat. No. 8,655,694 (May 29, 2012).
“Using dynamic barcodes to send data to a cellphone” by W. Boudville, U.S. Pat. No. 8,348,149 (Jul. 28, 2011).
“Cellphone changing an electronic display that contains a barcode” by W. Boudville, U.S. Pat. No. 8,532,632 (May 16, 2011).
“Data Communication System” by P. Bergel et al, US Patent Application 20120084131 (Nov. 19, 2010).

[The Web references are as of May 2014.]
en.wikipedia.org/wiki/Bump_(application)
en.wikiped ia.org/wiki/Hotspot_(Wi-Fi)
en.wikipedia.org/wiki/Rfid

### TECHNICAL FIELD

It relates to the use of a mobile device to control another device that has a hardware wireless tag.

### BACKGROUND

RFID tags are commonly used in supply chain inventory control. These are chips with antennas that radiate in a particular radio frequency range of the spectrum. Tags are attached to items, and contain identifiers of the items, like a model number or serial number or Stock Keeping Unit.

Tags can be active or passive. Active means the tag has a power supply and it radiates an electromagnetic signal. Passive means the tag gets an electromagnetic signal sent by a nearby reader device. The reader is typically carried by a person checking inventory. The tag emits a reply, with data encoded in the tag. The reply is powered by energy extracted from the reader signal. The reply is detected by the reader.

Tags are mostly used to track the objects they are on. Usually to confirm what object is or is not at a given location. While a tag might have data or point to data with information about the object, the tag does not lead to a control of the object.

### SUMMARY

A device has a hardware wireless tag as part of the device or connected to it. The device is connected to the Internet and runs a web server. The device controls some sensors or machinery. The tag encodes an URL whose address is the device. A person, Jane, scans the tag with a mobile device, like a phone. The phone makes a query to the server. The web page sent to the phone lets her control various aspects of the device.

The device lets a maximum number of users actively control it at the same time. Extra users go into a queue with a maximum length. When the queue is full, if the tag is active, it is turned off.

Jane can let “passive” users follow her activities, by getting read only copies of her web pages, when they scan the tag. She can specify whether they get the read only pages or any audio track for the pages. When a user scans the tag, he can be a passive user, by becoming a follower of any of the active users who allow this.

The device can have a speaker emitting an audio identifier of an URL that refers to the device, in conjunction with using a tag. The device could have several tags and speakers. These could be distributed over different locations for which the device has sensors or other machinery that control some aspects of the locations, or collect data.

If a tag is reconfigurable, it can be reconfigured if its device is put in or moves to a different location and gets a different Internet address. Or if the device periodically changes the URL in the tag. The latter can be done to favour giving control to users currently near the tag, rather than to users who earlier scanned the tag and recorded the URL and are now not near the device.

A reservation to control the device can be made over the Internet, while the user is not near the device. The reservation can be transferred to another user. The reservation can be activated by the user going to the device and scanning a tag for a time dependent URL. To tell the device that the user is nearby.

A user can scan the tag to get sensitive data directly from the device controlling the tag. For an active tag, the device can lower the power level to reduce the chances of eavesdropping by people nearby. If possible, other transmission properties of the emitted beam could be altered, like the beam spread or the orientation of the beam, to further reduce the chances of eavesdropping.

The format of the URL in the tag can be used by the phone to minimise energy consumption. If the URL says no more active users are currently allowed, and Jane has set a preference that she does not want to wait in a queue, then the phone does not need to make the wireless URL query to the server.

### BRIEF DESCRIPTION OF THE DRAWINGS

FIG. 1 shows Jane using her phone to control a device with a tag.

FIG. 2 shows users scanning the tag to control the device.

FIG. 3 shows Tim's page where he follows Jane's activities.

FIG. 4 shows Jane's page, where she defines what data her followers get.

FIG. 5 shows a fixed web server Alpha that Jane's phone talks to.

FIG. 6 shows a speaker emitting an audio of an URL to control a device.

FIG. 7 shows Jane going from one tag location to another.

FIG. 8 shows Jane sending a remotely made reservation to Lucy.

FIG. 9 shows a phone with a tag scanned by the device reader.

FIG. 10 shows Jane near an active tag that changes its transmission range and spread.

FIG. 11 shows logic in the phone to minimise power consumption.

### DETAILED DESCRIPTION OF THE PREFERRED EMBODIMENT

What we claim as new and desire to secure by letters patent is set forth in the following claims.

This submission refers to our earlier submissions to the US PTO: “Cellphone changing an electronic display that contains a barcode”, filed 16 May 2011, U.S. Pat. No. 8,532,632 [“1”]; “Using dynamic barcodes to send data to a cellphone”, filed 28 Jul. 2011, U.S. Pat. No. 8,348,149 [“2”]; “Transmitting and receiving data via barcodes through a cellphone for privacy and anonymity”, filed 4 Oct. 2011, U.S. Pat. No. 8,707,163 [“3”]; “Colour barcodes and cellphone”, filed 16 Dec. 2011, US patent application 20130157760 [“4”]; “Mobile device audio from an external video display using a barcode”, filed 25 May 2012, U.S. Pat. No. 8,708,224 [“5”]; “Dynamic group purchases using barcodes”, filed 29 May 2012, U.S. Pat. No. 8,655,694 [“6”]; “Chirp to control devices”, filed 9 Oct. 2012, US patent application 20140098644 [“7”]; “Barcode to enhance mobile multiplayer games”, filed 22 May 2013, U.S. patent application Ser. No. 13/986,650 [“8”].

While we discuss RFID as one use case, the submission also pertains to Near Field Communication [NFC]. In the context of the submission, the latter is considered equivalent to RFID, but with much shorter range. More broadly, this work can pertain to any method of wireless transmission.

In what follows, the word “tag” is used to mean a sticker or other physical entity that holds wireless circuitry. Typically but not exclusively, for RFID ranges. It does not mean a “tag” as in HTML or XML or SGML. In the latter, there might be a body tag “<body>” for example. The latter meaning of tag refers to a markup text string put in a larger text string or document (like a web page). We make this distinction explicit, because we will also talk about an Universal Resource Locator (URL). This points to a web page written in HTML; leading to possible confusion about the meaning of “tag”.

In the prior art, there is an item of hardware called a RF [radio frequency] beacon. In this submission, when we describe an “active tag”, we include the latter hardware.

Also, we use “reader” to be an electronic device that can detect a wireless tag, and not a human.

We use “root” to designate the highest level type of user on a computational device, regardless of its operating system. This is the term from unix or linux devices. Equivalent terms are superuser or system manager.

We will refer to an “active tag” or an “active user”. The former is a tag that transmits electromagnetic energy from a connected power source. The latter is a user currently controlling part or all of a nearby device. Likewise, we will refer to a “passive tag” or a “passive user”. The former is a tag that does not have a connected power source. The latter is a user waiting to control a nearby device.

The submission has the following sections:
1: Base Implementation;
2: Multiuser—active users and passive users;
3: Two network devices;
4: Speaker;
5: Antenna Orientation;
6: Reconfigurable tag—“Are you still there?”;
7: Cellphone with a tag;
8: Cost;
9: Re-scanning a tag;
10: Turning on a tag;
11: Using an app on a cellphone;
12: Minimising energy consumption on a mobile device;

1: Base Implementation;

A tag is commonly used to associate information with a physical object near the tag. Often, the tag might be attached to the object. For inventory control or supply chain management. Here, the object while currently fixed in location might have earlier been at a different location. Or, in the future, it might be at another location. Another related use is object hyperlinking. Here the object might be at fixed location. For example, the object might be a statue or monument in a public park.

In either case, the tag might encode an URL that points to a web page with information about the object. The web page comes from a web server located somewhere on the Internet. In general, the location of the web server is not near or the same as the location of the tag or the object it refers to. When the context is the supply chain, the server might not know where the object is.

A person, Jane, near the tag and its object uses a mobile device, like a cellphone. Her device detects the tag, reads the URL and then brings up the web page on the phone browser. She avoids having to explicitly type the URL on her device, because that is slow and error prone.

There has been recent work on RFID tags. There are various ways to set the contents of a tag. The configuring is done by electronics that is part of the tag, or attached to it in some manner.

Another idea in the prior art is the use of devices like laser printers on an electronic network. Like a subnet of the Internet. The device might have a control panel. But it might also be controllable via commands sent to it on the network, Thus a network printer can be accessed by users via their computers on the network. A user can easily print a file by sending it to the printer's addres (and some suitable port).

We combine and extend those elements of the prior art as follows. Imagine a device that performs or will do some action or actions. Maybe it collects data from its sensors, or from a network of sensors. The data could be temperature, or pressure or humidity. Or perhaps the device controls the Heating, Ventilation and Air Conditioning [HVAC] in a building. Or perhaps the device shows and controls the security cameras in a shopping mall, stadium, university or airport.

The device has some computational ability. It has an operating system. With at least two classes of users. The top user is root. Then there are regular users. An elaboration is where there are 3 levels of users. An intermediate level, called “operator” perhaps, between root and user. The operator can do certain management steps that the user cannot. While root can do all management steps.

The device is installed in some location to do its tasks. It has a connection to the network. Without loss of generality, we take the network to be the Internet. Often the connection might be wired. During installation, the device acquires an Internet address, like 10.20.30.40. This example assumes IPv4, but similar remarks could be made for IPv6. How exactly the address is set in the device is outside this submission. It might be a combination of manual and automated steps, or fully automated.

Once the device has its address, it starts a server to listen for queries from the network. In general, these might be in any format that sits on top of the Internet Protocol. For simplicity, we take the queries to be http or https, so the server is a web server.

A step occurs where the device reconfigures or configures for the first time a tag that is part of the device. The tag will encode an URL referring to the device. The URL might be “http://10.20.30.40/”. Preferably, the step is automated. That is, once the address of the device has been determined, then this is subsequently and automatically done. Perhaps by some controlling script or program running in the device.

Note the following about the prior art. There are several ways to set the RFID tag. These might be described by others as “reconfigurable” or “configurable”. The terms are sometimes used interchangeably. But there is a nuance. A specific method might only be able to set the tag once. So it is configurable but not reconfigurable. While another method can set the tag several times. So it is reconfigurable. But the term “configurable tag” is redundant. Any tag needs to be configurable at least once, to set its contents. If not, the tag is defective.

The tag can be active or passive. If active, it starts radiating the above URL. If passive, it needs a person, Jane, to come along with her reader device to activate it.

In the prior art, a specific method of making a tag might only be able to make an active tag, or it can only make a passive tag. Likewise, if a method makes a reconfigurable tag, the latter might be only be active or only passive. Or the method could make both types. The point is that a reconfigurable tag is not to be equated with an active tag.

Jane at some later time comes near the device. She has a mobile reader. We take this to be a cellphone with the appropriate hardware and software to detect the tag. It could instead be a tablet, PDA, notebook, Heads Up Display, or another other mobile electronic device capable of this.

Via the web page that appears on her phone, from the device, she can control various aspects of the device. The device might or might not be visible to her. If it is visible, it might or might not be physically accessible to her. The owner of the device perhaps wants to protect it from vandalism or loss, and so does not make it physically accessible. Hence the access is remote, via the network.

Why might the device not be visible? It could be in a locked cabinet. Where presumably the signal can still be transmitted through the cabinet. Or the device might be blocked from Jane's line of sight. Perhaps boxes are stored in front of the device, blocking her view. Since RFID is non line of sight, this plays to a reason to use it. Or Jane is a pedestrian on a sidewalk and the device is on a balcony on a floor above street level.

If the device has a screen, and if this screen can be seen by Jane, then her actions on her phone might cause changes on the device screen, in addition to changes on her phone screen. Where the device screen is meant to be used by Jane, via actions she does on her phone.

There is a feedback loop. From the scanning of the device's network address on its tag to the user controlling the device from her phone.

Though the device is on the net, it might restrict access from the net, by requiring a login from only the root or operator.

When Jane scans the tag and gets a web page on her phone, this might first require her to login. Where this assumes she already has a username and password, by means outside this submission. Or, Jane might be able to do commands, without having to log in. Though these commands might be a subset of a larger set accessible only to a person with an account.

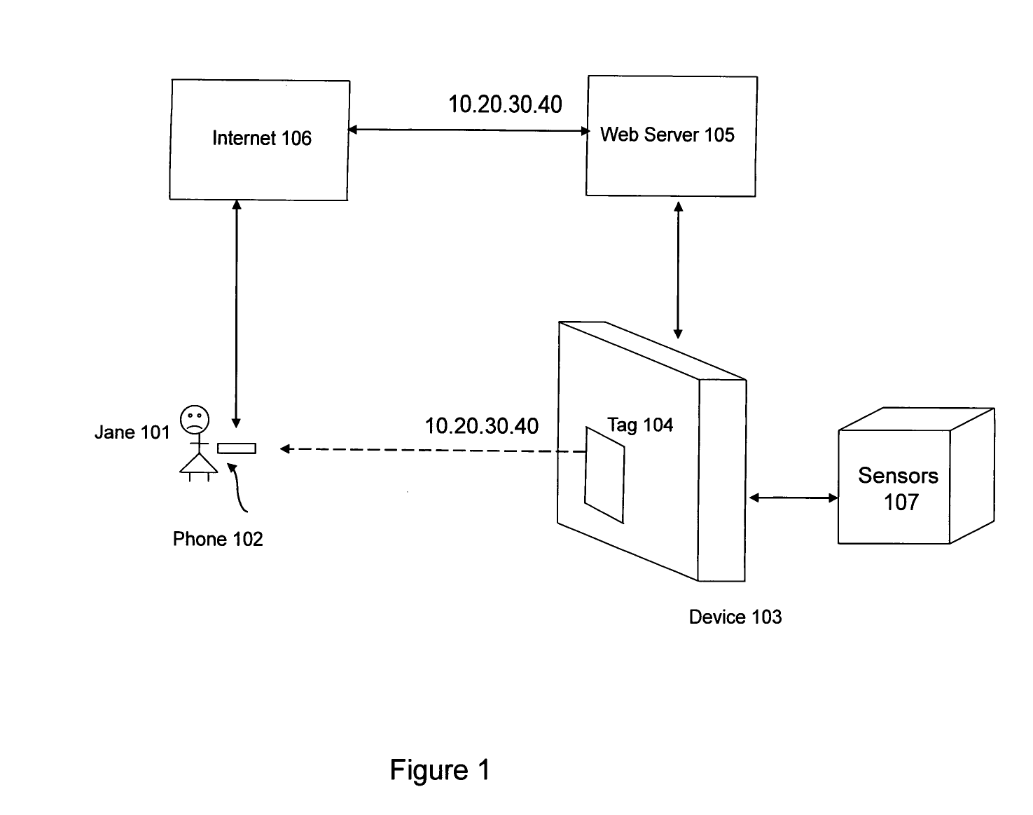

FIG. 1 shows the overall process. Jane 101 has Phone 102. She is near Device 103. The latter has a Web Server 105, which connects to the Internet 106. The figure shows Web Server 105 as separate from Device 103 for clarity, though in practice, it is likely to be running as software inside Device 103. The device has Tag 104, which is likely to be on or part of an external surface of the device. Device 103 also contains or is connected to Sensors 107. The latter is a catchall for whatever internal or external instrumentation or functionality that is used by Device 103.

Phone 102 has the necessary reader that lets it read Tag 104. The reader might be an attachment to Phone 102, or built into it. The decoding of Tag 104 on Phone 102 leads it to start a browser (not shown) and the browser or equivalently the phone contacts Web Server 105 via Internet 106.

For clarity, Tag 104 is shown as one entity. Though in practice, it will have some substructure, which depends on the particular implementation of the tag technology.

Next to Web Server 105 is a label “10.20.30.40”, which is the example value of the Internet address of Device 103. This label is next to the connection between Web Server 105 and Internet 106, to indicate that it is the address seen (or assigned to it) by the Internet.

Then, above the arrow going from Tag 104 to Phone 102 is the label “10.20.30.40”. The same value as the prior label. To show that Tag 104 encodes that value within its URL. For clarity, the entire URL in Tag 104 is not shown in the label, but only the essential address itself.

A key utility of this submission is that the user does not have to type out the URL of the device. A second advantage is to suppose what would have to happen if Jane had to type the URL. She would have to read it from a display or hardcopy label. That implies the need for a display visible to Jane, or for the printing and installing of a hardcopy label. The latter steps are manual. Thus using the tag means less hardware or less manual steps by personnel installing the device. And not just less manual steps by Jane (the generic user).

Another advantage is if Device 103 has a lot of controls. Instead of needing an elaborate physical control panel, and having users be able to access that, Jane uses her phone. Granted, the user interface of the web pages needs to be carefully designed, because of the small screen of the phone. But the flexibility of using web pages can let her access very complex controls.

The user can now alter some internal state of the device. This state in part or entirely is held in computational volatile or non-volatile memory. (The latter might mean the state is stored on a disk.) Often, the state is held as digital data.

Perhaps more importantly, Jane might be able to change some “physical” characteristic of the device. By this, we mean an aspect of the device or its surroundings that would typically be considered a non-computational and macroscopic property. By macroscopic, we mean a change that can be detected by a person unaided by any tools or instruments. Typically using the natural senses of sight, sound, smell, and touch.

For example, Jane changes the temperature of a part of the device or of a room, where the room has HVAC, where the device could be considered to be the HVAC or the controller of the HVAC, rather than the room itself. Through her skin, she might be able to detect any temperature change she caused.

Or Jane locks or unlocks a door. Here, the door might be considered part of the device, or the device might be in part the locking mechanism of the door. If the door is initially closed and locked, and Jane uses the web page to unlock it, then she can detect this change by opening the door.

Or she instructs a security camera to focus and zoom in on a given orientation, to look at suspicious activity. In the latter case, while the orientation and zoom values might be held in memory as part of the computational state of the device, the physical state would be the actual turning of the camera and the adjustment of its lens to do the zooming.

Why can't the device just run an Internet Hot Spot instead of using a tag? That is, it runs a WiFi transceiver, listening for phones making WiFi queries. One reason not to do this might be to minimise power consumption. A Hot Spot could take more power than running an active tag. While if the tag is passive, then the power that the device has to furnish to it is zero, once the tag has been configured.

Note that the device in general could be doing other tasks, as alluded to above. These tasks take energy. So even if the device is connected to the electricity grid, it may still be desirable to minimise power consumption.

Having said this, the submission does not preclude the use of a Hot Spot. But the latter might be considered part of the prior art.

Along these lines, this can be why a tag is used, instead of the device having an electronic screen where it could show a barcode encoding the URL. The latter mechanism was our first US patent “1”.

Suppose the context of the device's use is that it could have a screen visible to a nearby user. A barcode on that screen implies that the screen has to be powered up continuously. Having the screen go dark in a low power mode means the barcode cannot be seen by the user.

The scanning of the tag can give a page on Jane's phone where she can turn on that screen. And perhaps she can also choose what appears on the screen.

If the tag is active, then when Jane scans it, the device might turn off the tag. Maybe for the duration when Jane is interacting with the device via her phone. So someone else cannot scan the tag. When she is done interacting, the device might turn on the tag.

Alternatively, for an active tag, when Jane gets the page on her phone, she might be able to turn off the tag, or to adjust its power, and hence adjust the range at which the tag can be scanned by others.

2: Multiuser—Active Users and Passive Users;

Jane scans the tag and gets control of the device. (This control in general will be less than that of root.) Bob comes along, with his phone, which can scan a tag. He wants to also get control.

The device might only let one user control it at a time. One way to do this if the tag is an active tag is for the device to turn off the tag when Jane gets control. After she relinquishes control at some later time, the device turns on the tag. This means that when Bob tries to scan the tag when it is off, he fails. He would have to try again later.

Another method is where the active tag stays on or if the tag is passive. So another person can still scan it. If Bob does so, he is put into a queue. He gets a web page from the device that tells him of this. The device records the network address of Bob's phone, and holds that in a table that is of people queued up. Jane gets exclusive use, for some maximum fixed amount of time. At the end of this, or earlier if she has been idle (where the duration of “idle” is defined by the device), she is logged out and Bob gets control.

When Jane has control, the device might periodically send web pages to Bob's phone, or equivalently alter the page on his phone, with updates about how much time he has left to wait. An intent is to keep him near the device, instead of walking away.

The page on Bob's phone might have a button saying “bye”. If Bob picks this, he is telling the device that he is walking away. It can remove him from the queue. If there is no one else in the queue, and Jane is still active, then the duration of her activity can be extended. This duration can be indefinite, if no one else enters the queue.

The exclusive use by only one user at a time might be for a device where this is necessary or desirable. For example, suppose the device controls the temperature of a room or the orientation of a single camera.

In the prior art, there is scant if any discussion about under what conditions an active tag should be turned off. Apart from when power is running low. Without the case where a tag leads to control of the device that it is attached to, there is little need to even consider doing so. Thus one of the new aspects that we introduce in this submission is a discussion of the reasons and actions around why to turn off an active tag.

A variant is where when Bob scans the tag, he gets a page that lets him control certain properties of the device, but not others. The latter are being controlled by Jane. For example, if the device has several cameras, and Jane has exclusive control of one of these. Bob could get control of other cameras.

Suppose it is possible to have a maximum of n active users at a time, where n>1. After n users, if the tag is active, the device turns it off to prevent others scanning it. Or the device puts extra users into a queue. With people waiting, it enforces a maximum login time or minimum activity on the first n users. As actively controlling users are logged out, people in the queue are given the chance to get control. There might be a maximum length on the queue. When this is reached, and the tag is active, it is deactivated.

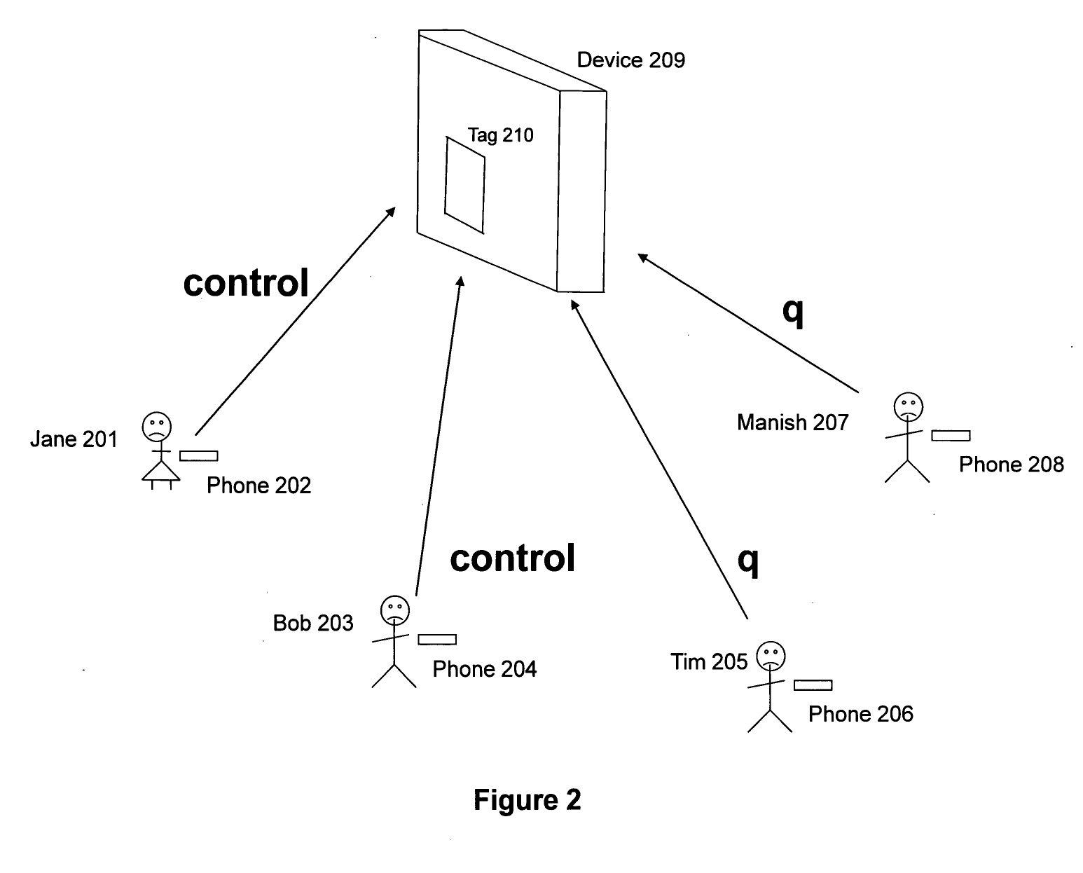

FIG. 2 shows n=2. It assumes an active tag. Jane 201 uses her Phone 202 to scan Tag 210 on Device 209. She gets control on Phone 202 and is doing various activities with the web pages sent from Device 209. Bob 203 uses his Phone 204 and is doing likewise. This is indicated by the labels “control” on the arrows from Jane 201 and Bob 203 to Device 209. While Jane and Bob are interacting with Device 209, Tim 205 with his Phone 206 and Manish 207 with his Phone 208 come within range of Tag 210. They scan it. But with a maximum of 2 active users, Device 209 puts them into a queue. This is indicated by the labels “q” on the arrows from Tim 205 and Manish 207 to Device 209.

Suppose the queue was at its maximum length and the active tag was deactivated. And later the queue is below that length. At some point the tag can be reactivated. The device might have heuristics to decide at what exact point to do so. It might be immediately after the queue has an extra slot. Or the device could wait till several slots are available.

Above, we assumed that if there were several simultaneous users, they were doing active things when connected to the device. But there could be another type of user. A passive user. An observer, watcher or follower. We consider these terms to be equivalent in the sense described below.

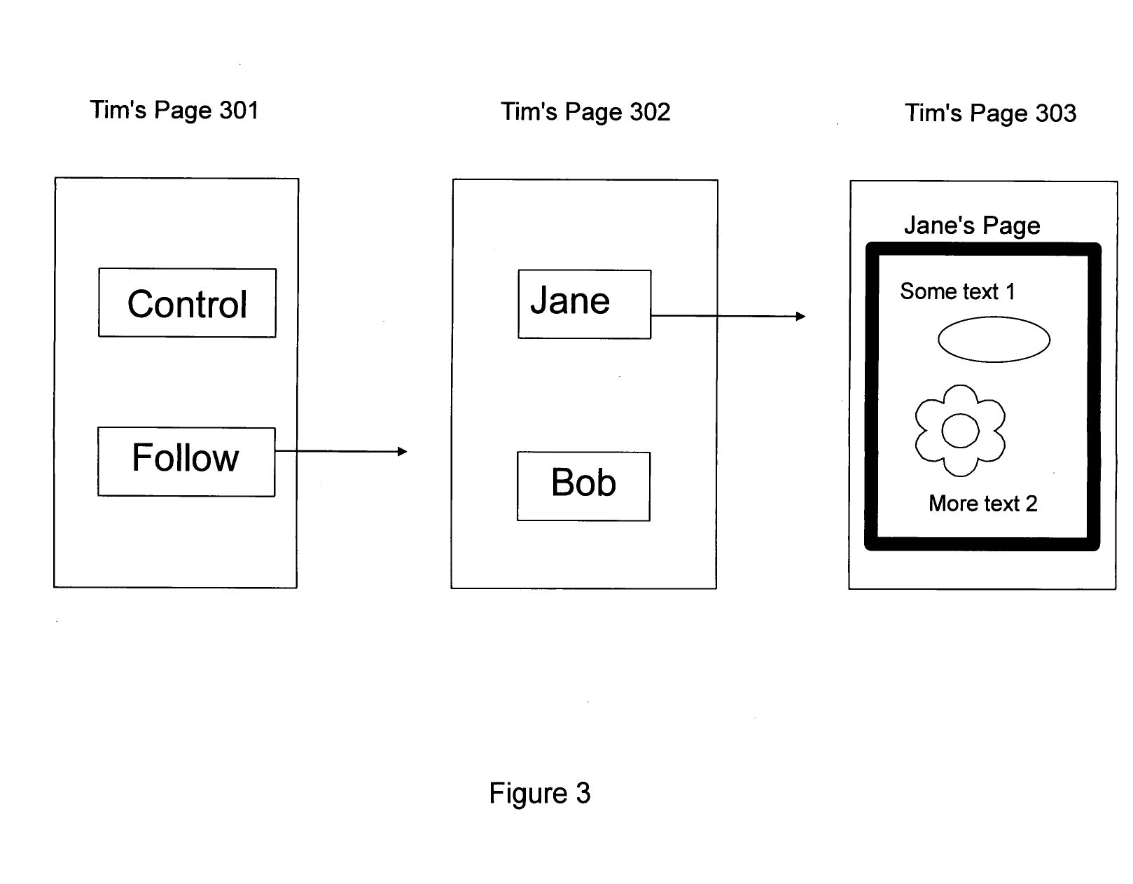

Imagine Jane and Bob are the active users. Tim comes along. The tag is assumed to be scannable. Tim scans the tag. He gets a web page with two choices. Control. Follow. This is shown in FIG. 3. See the item Tim's Page 301, with the choices. He can only pick one of these. If he picks Control, he gets the same type of control as Jane or Bob.

If he picks Follow, he gets Tim's Page 302, listing which active users he can follow. The only choices are Jane and Bob. He picks Jane. Now he sees Tim's Page 303. Whenever Jane does something on her phone page, and the latter is changed by the server, the server sends a modified copy of her page to Tim's device. The buttons and links in it are disabled. He gets a read only copy. This copy is embedded in a web page with a label “Jane's Page” to remind Tim of who he is following.

In FIG. 3, consider the item Tim's Page 302. It shows buttons with some identifier about the active users. Like their names, where it is assumed that when those users became active, they told the device their names. Or perhaps they have logged in previously and the device has gotten such information then. But to the extent that the device knows other information about the active users, it might also put these into Page 302. To help Tim make an informed decision about which user to follow. The device might also give the active users some control about whether or what parts of their information will be shown on Tim's phone. The information on Page 302 might also include what the active users are currently doing.

Also, consider the item Tim's Page 303. Apart from showing what Jane is getting on her phone, Tim's web page could also show a button that lets him go back to Page 302. To pick another user to follow. When he does that, the contents of Page 302 could have altered from when he first saw it. More users might be active, and some previously active users might have left.

A variant is when Jane scans and gets a page on her phone. The page might let her prevent others following her. Or, if she lets others, she might be able to restrict the maximum number of followers.

An elaboration is when Jane scans and gets a page. Suppose the device also will send audio with future pages sent to her phone. She might be able to restrict whether others can get this audio, even if they can get a read only copy of the pages she gets.

A variant on the previous paragraph is where she can specify that others get only the audio track, and not the read only copy of her pages. In this case, the device could send to the others a “generic” web page with the audio she gets. Their page could say that that they are only getting the audio.

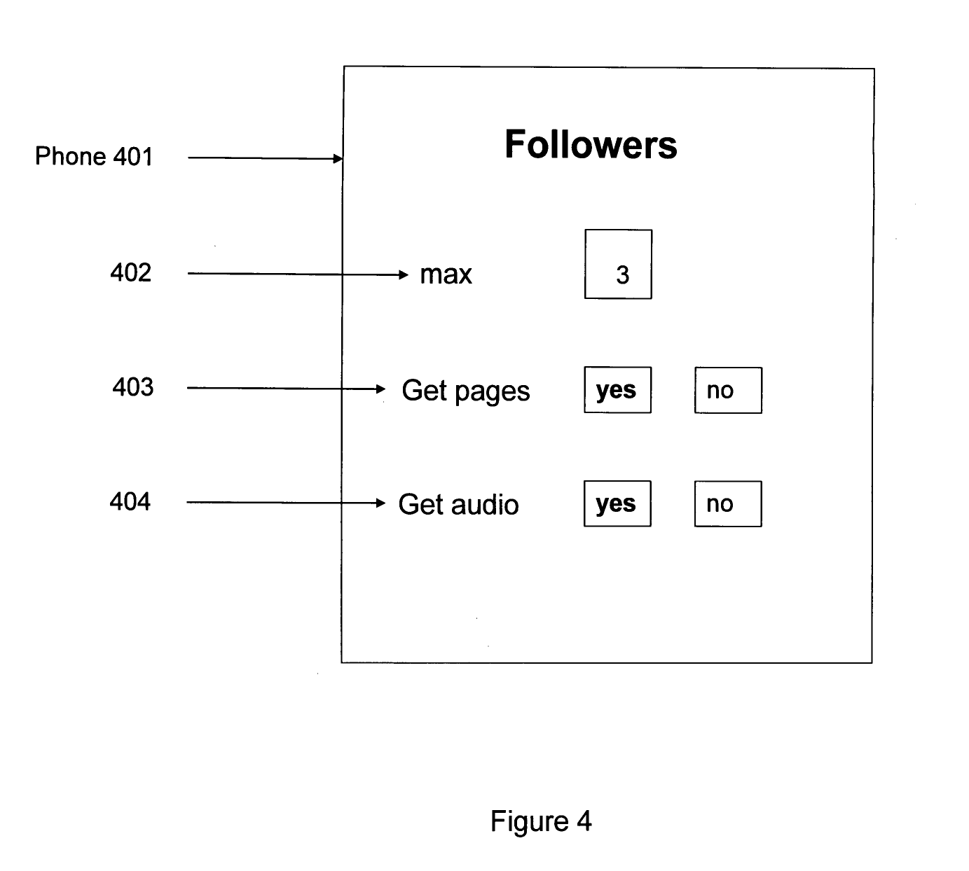

FIG. 4 shows this. Phone 401 is Jane's phone. Item 402 has an input text box in which she can enter the maximum number of followers. Currently, the value is 3. Item 403 has radio buttons “yes” and “no” (which means only one of these can be picked). Yes means a follower gets a read only copy of the pages she gets, but no audio that might come with those pages.

Item 404 has radio buttons for the yes and no buttons. The buttons are mutually exclusive. Here, yes means a follower gets the same audio that Jane gets. The display of yes in bold for items 403 and 404 means that these are the current choices.

The treatment in this section follows that of our patent “5”, which used a barcode on a screen instead of a tag.

Much if not all of this section is meaningless in the prior art, when a person scanning a tag cannot control the device or object that the tag refers to. There is no need to restrict the maximum number of users who can scan the tag and get pages from a server. Apart of course from the computational and network bandwidth limits of the server.

A possible question is why should a user, Tim, who is going to be a passive user, scan the tag? Why cannot he just directly contact in person a nearby active user, Jane, say, and ask to either see her screen or for her to send him screen captures or an audio feed?

First, even if Jane is willing to show him her screen, it is small. It is hard for her to do controlling of the device and also let him see her screen. And even if she does so, it is even harder if someone else comes along and want to also see her screen.

Second, Jane and Tim might not know each other. So they do not have each other's email addresses or other electronic addresses. It is error prone for one of them to type the other's address. Each key click is a source of potential error. At least one of Jane and Tim needs the other's electronic address, in order for Jane to somehow send Tim images of her screen via the network.

Third, Jane might not have the necessary software on her device to easily send screen captures, or an audio feed, to another person's device. But all users can be expected to have a browser on their devices. And via the browser, they can get web pages from the device with the tag.

In our submission “8” we discussed this in the context of two strangers with mobile devices near each other. The simplest way for the two to play a two person application (e.g. game). The mechanism was for one person to show a barcode in her device screen, and the other to scan it with his device camera. While that mechanism differs from that of the current submission, there is similar reasoning.

In this section, we described several active users. Where each user perhaps separately controlled some subset of the device's controls. Another possibility is a multiuser interaction, where the users enter by scanning the tag. They take part in some such interaction, where they are jointly affecting or controlling some aspect of the device. The interaction can be a game, if the users are performing this primarily for recreation.

To the users, the game might be only visible on their phone screens. This is equivalent to them somehow playing a multiuser game on their phones, where other means are used to enter the game. Or, if the device has a screen visible to some or all of the players, the device screen might also show events in the game. Here, the phone screens might be mostly used as game controllers, and the game is mostly visible on the device screen.

Another game alternative is where the players might control physical objects that, say, move in some area or volume visible to the players. The objects could be remote controlled toy cars. The game could be where each car is controlled and driven by one player, and the players compete by racing the cars on a lot near them.

The power transmission level of a tag might be a function of the current number of active users, j, and also the current number of passive users in the queue, k. One simple method is to have the power level inversely proportional to j+k. When j+k=0, the tag radiates maximum power, so it can be detected over a maximum area. As the number of active and passive users increases, then the power level is reduced. Perhaps as one way to prevent the system of the device being overloaded with users. Earlier, we described the use of the queue for passive users, as a way to restrict the number of active users, and yet keep those users unable to become active users. The adjusting of the power level can act as a different type of throttle.

Above, we described using an active tag and turning it off under various circumstances. For an active tag, this usually means turning off the power to it, so that it does not transmit a signal. But suppose the tag is passive. If the tag is reconfigurable, then turning it off is defined to be changing the data contents, so that the new data is no longer a valid URL. It might be, e.g. “null”. This way, even if a person comes along with a tag reader and transmits a power signal, the reader will not get a valid URL.

Consider again where Jane is actively controlling the device. She wants to or has to log out. Others might already be active users or in the queue of passive users. Jane can pick an option to become a follower of an existing active user or a new active user, who takes her place as an active user. The device can send her a page indicating the list of active users. This list might have nicknames of those users. Assigned by the users themselves or by the device. Likewise the page or another page could have a similar list for the queued users.

If Jane picks a user, then over some duration, the device sends a data feed of actions or data received by that user. This feed can be sent to an electronic address of hers, like an email address or an URL, for example. The feed might be streaming or batch. For batch, the device might periodically group the data and then sent it as an email, for example.

Suppose Jane picks an active user. An additional option could be that when that active user logs out, Jane still gets a feed from another active user, who perhaps replaced that active user.

The device might restrict what data will be sent in the feed. It might also apply some anonymising steps to the feed, to perhaps hide some details pertaining to the identity of the active user.

3: Two Network Devices;

Earlier, we described the tag as emitting an URL. But suppose there are two devices on the network. The first device is as earlier. When it is put on the network, it talks to a second device (“Alpha”) on the network, at a fixed address known to the first device. Suppose that address is alpha.com. When the first device registers (“calls home”) with Alpha, the latter has a table. Each line is an instance of the first device. One field (column) is the address of the first device. The other field is an identifier (key) assigned by Alpha. Suppose the identifier is 5. Alpha sends this back to the first device.

The first device broadcasts this “short code” “5” in its tag, instead of the earlier “http://10.20.30.40”.

When Jane scans the tag, it is assumed that she has from some earlier setup an application on her phone which gets this “5”. The application has “alpha.com” prestored. It makes the prefix “http://alpha.com/”, appends “5” and starts a phone browser and loads it with this URL. When Alpha gets this, it extracts 5 and looks in its table. It then sends commands to the device and also sends a web page to Jane's phone. So now she controls the device via Alpha. In this case, the device need not run a web server. Though it needs to run some program that listens on the network for commands from Alpha.

Or Alpha sends Jane's query to the device, which then replies directly to her phone.

An alternative to this URL fragment being broadcast by the tag is where the device makes a full URL for the tag. The address in the URL is Alpha, and the portion to the right of the domain is the device's address, suitably formatted. For example, the device tag might say “http://alpha.com/10-20-30-40”. When Jane's phone makes this query to Alpha, the latter's server extracts “10-20-30-40” and makes the address 10.20.30.40. Hence Alpha knows that the phone is near the device with that latter address. Alpha sends commands to the device and web pages to the phone. In this case, the device need not be running a web server. It just needs to listen on a suitable port for commands from Alpha.

This makes a longer string for the tag. But it has the advantage that the phone does not need a predefined application that has “alpha.com” stored.

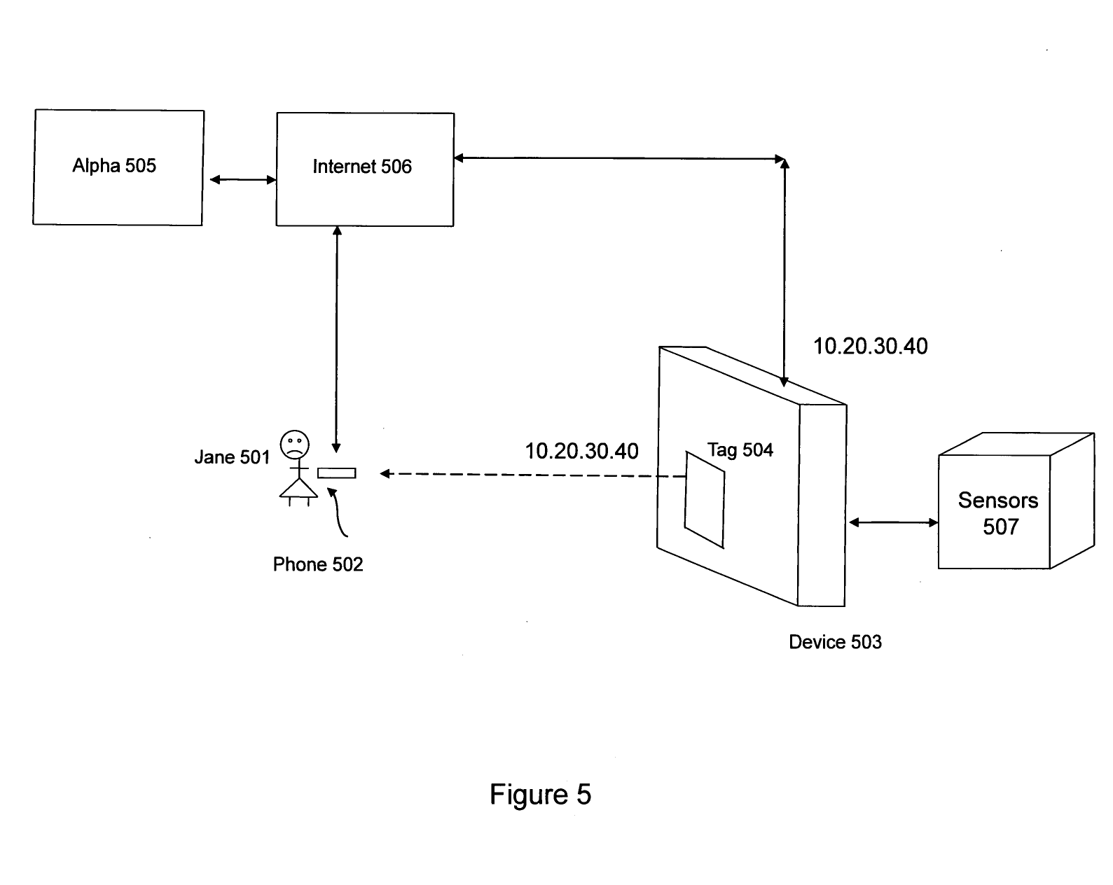

See FIG. 5. Jane 501 corresponds to Jane 101 in FIG. 1. Phone 502 corresponds to Phone 102. Device 503 corresponds to Device 103. Sensors 507 corresponds to Sensors 107. Tag 504 corresponds to Tag 104. Phone 502 sends page requests to Alpha 505. The latter sends commands to Device 503. The label 10.20.30.40 on the connection between Device 503 and Internet 506 means that Device 503 has that address on the Internet. The label 10.20.30.40 on the connection between Tag 504 and Phone 502 means that this address is encoded in the right hand side of the URL in Tag 504.

This is in essence our patent “1”. Where instead of a tag, a barcode was shown on an electronic screen and the user phone scanned the barcode with a camera.

4: Speaker;

Above, we did not assume that the device used a speaker. If it has a speaker, it might use both its tag and sound from the speaker, to broadcast an URL or an identifier of an URL. Or a fragment of the URL. If sound is used, this can be via any sound encoding method. The device might use both methods to increase the ability for users to control it. Only some users might have a phone or other mobile device with the hardware of a reader. While a functioning phone can record audio.

One such audio method is “Chirp”, where the data is mapped to a hash and the hash is mapped to audio that sounds like bird song. See Bergel's patent application and our earlier submission “7”. Our current submission can use Bergel as a mechanism for making the audio.

Suppose the device has both the tag and a speaker. When Jane scans the tag, the speaker might not be broadcasting. After the scan, the device might turn on the sound. Or she might have an option on her page to do so.

Instead, suppose the tag is active and turned off. While the speaker is broadcasting the URL. If Jane gets the URL from the audio, then the web page on her phone might let her turn on the tag. And possibly turn off the speaker.

If sound is turned on, and the tag is active, the device or Jane might turn off the tag.

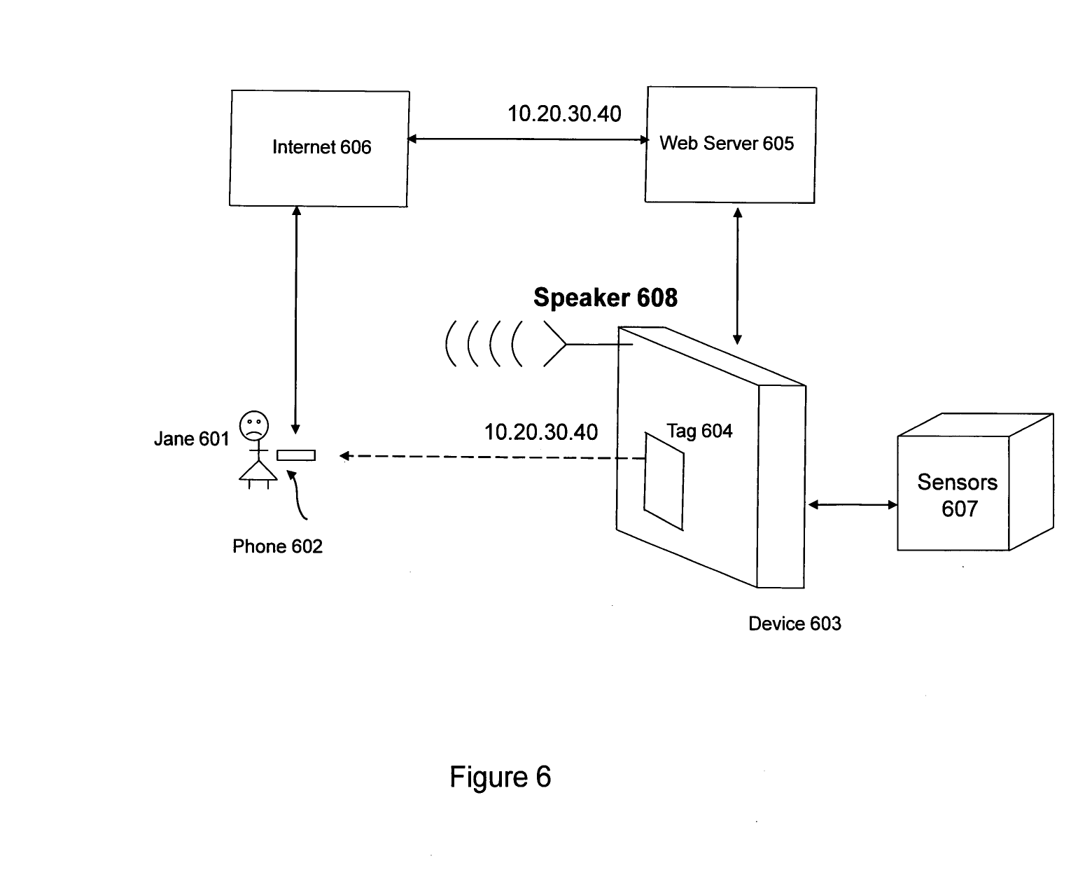

See FIG. 6. Many of the elements are the same as FIG. 1. Jane 601 is Jane 101. Phone 602 is Phone 102. Device 603 is Device 103. Tag 604 is Tag 104. Web Server 605 is Web Server 105. Internet 606 is Internet 106. Sensors 607 is Sensors 107. What is new is Speaker 608. It transmits an audio signal encoding an identifier of an URL.

For clarity, FIG. 6 omits secondary servers on the Internet, that might be needed depending on the precise audio encoding scheme. These servers would be used by Jane's phone, to fully decode the data from the audio into an URL, where the latter points to Web Server 605. More details about the secondary servers are given in Bergel and in our earlier submission “7”.

Another reason for having both a tag and a speaker is that the speaker might extend the range at which the device can be controlled. The tag could be shorter range. Related to this is where the speaker connected to and controlled by the device, but is not near the device, while the tag is on the device.

Here we discussed multiple “transmitters”. Where a speaker is inherently a transmitter. And where a tag could be a transmitter if it is active. And we generalise “transmitter” to include the case of a passive tag.

There could be multiple tags. FIG. 1 shows only 1 tag. But if Device 103 could have several tags. For example, suppose it controls the HVAC in several rooms. Each room might have a tag. Because a single tag would likely not be scannable across all the rooms. Suppose the tags all encode the same URL.

When Jane scans a tag, she gets a page that lets her pick which room to set the temperature in, for example. This can be simplified for her if each tag also encodes an id of a region that it controls. So to the right of the domain name in the URL might be “j=5”. The “j=5” substring indicates a region or room. The “5” tells the device which room Jane is in. It has an internal table that maps from the j values to the hardware controls for each room. It can via Web Server 105 send her a page to control the temperature in that room.

Suppose Device 603 is distributed over some set of regions or areas, with multiple tags or speakers. A region might have a tag or speaker transmitting within it. The region might have a maximum limit of active users associated with it, where the active users become so by scanning a tag or decoding an audio. And the region might have its own queue. So Device 603 maintains separate lists of active users and queues for each region.

The maximum number of active users and the queue lengths could differ across regions.

Section 2 discussed the case of several users per tag. The users were active or passive. That discussion can be repeated here for each region. Where instead of just one tag, there could be several tags or speakers in a region. And where Section 2 described how an active tag might be turned off or on, this might also apply to turning off or on any speaker.

5: Antenna Orientation;

Suppose the tag is active. It has an antenna. Suppose the device can change the tag orientation. Initially, it might emit most of its signal in a given direction. Jane scans it. After this, the device might change the orientation. Or Jane might be able to change it from her web page. One reason could be if it is expected that users can be in a crowd. Where it is desired to pick users from different parts of the crowd.

6: Reconfigurable Tag—“are You Still there?”;

Our examples of devices having a tag have mostly been for devices that were assumed to be inherently stationary. Like the HVAC system of a building. Or the surveillance cameras of a building or set of buildings. But now consider where a device will regularly change location. It will reconnect to the Internet, but with a different address at each location. This is one context is where a need for a reconfigurable tag arises. So that the device can run a web server and so that the tag refers directly to the new address of the server.

A tag that can only be configured once will not, in general, enable the aspects of this submission where the device changes location and runs a web server that the user is meant to connect to. In this case, the tag will need to refer to the URL of another server, at a fixed network address. Where that server is periodically updated with the new network address of the device.

Now imagine that the device is static, as was implicitly assumed in the earlier sections. Why might a tag be reconfigured?

One reason is that a pedestrian who scans the tag and records the URL might use it at some later time, when she is not near the tag. Under some circumstances, this might not be desired. The owner of Device 103 could prefer that the users be near it. One answer is to periodically change the URL encoded in the tag. An extra field is added, with an identifier label and a random value. The latter is changed from time to time.

Suppose Jane records the URL and tries to use it later. The web server might return a page saying “expired URL”. Or it might still let her control certain aspects of the device. Or it might only let her read some data, and not control any aspects.

Or suppose Jane scans the tag when she is near it. She gets control and is actively interacting. During this, she might walk away. To prevent this, the device might periodically send her a page that says in part, “rescan the tag”. Prior to doing this, the device has altered the URL in the tag as described above. If Jane successfully rescans the tag and her phone browser sends the decoded URL to the device, then the device knows she is still nearby.

Or suppose we have a user Tim, who is near the device, scanned the tag and is waiting in a queue because Jane is active. The device can check that users in the queue are still near, by having them scan the tag. It sends them a web page telling them to do so.

A variant on the previous paragraph is suppose Tim is in the queue. He is going to be promoted to an active user, because one of the active users has left. The device might ask Tim to rescan the tag, as part of the promotion process.

Note that the events in the previous paragraphs can happen close to each other in time, and using the same tag. The device already knows the address of each active and passive user. So when a user sends the URL to the device, the device knows already the user, and whether she is currently active or in the queue.

Suppose the device has the tag encoding that temporary time dependent URL, with a random field. A new user, who has never scanned the tag before, comes along and scans the tag. This is ok. The device can follow the processes of the earlier sections in dealing with this new user. The device knows that, because this user is coming from an address different from the current active and passive users.

The above can also be done if the device controls speakers playing audio encoding identifiers of URLs. Or if the device also has screens showing barcodes encoding URLs.

None of this requires the device to use other methods of detecting the user presence. Like cameras operated by the device, that might then feed into pattern recognition algorithms. The above method of detecting a continued user presence makes a simple use of existing hardware.

Suppose the device has tags located over a dispersed region. Jane has scanned a given tag and is interacting with the device and staying near that tag. The device could send Jane a page with a map or instructions. Telling her to go to another place also covered or accessed by the device.

Possibly, when she is travelling, her phone updates its location on its screen. But note that the map, the choice of a possibly optimal route and the updating of her location are done by means external to this submission. There has been voluminous prior art of the subjects of mapping, route finding and geolocation.

When Jane gets to the destination, she might press a button on her page, to tell the device. Then the page on her phone, which might have been updated by the device after she pressed the button, tells her to scan the tag at that place. The tag was updated recently. So if Jane had recorded or gotten, by whatever means, a prior URL encoded in the tag, that prior URL would be rejected by the device. Getting the current URL proves to the device that she is at the destination. Or at least, it is an acceptable level of proof, in this context. More stringent steps could be added if desired.

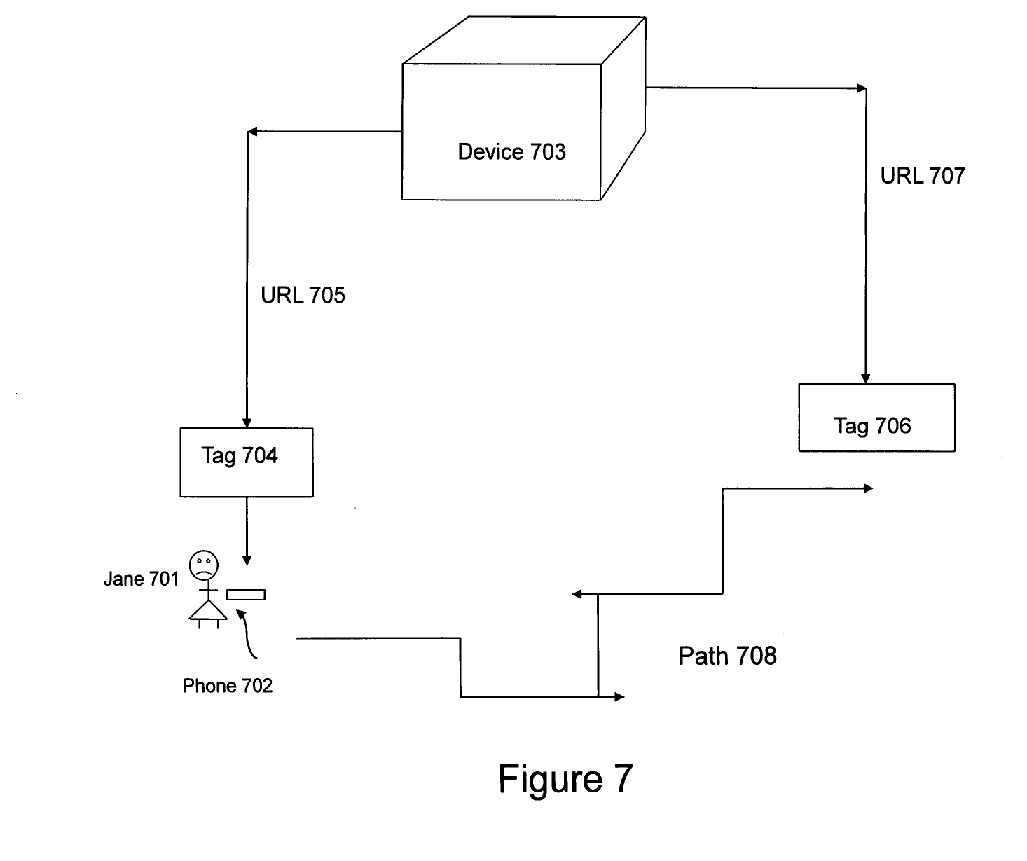

See FIG. 7. Jane 701 has Phone 702. She is near Tag 704, which gets URL 705 from Device 703. She scans Tag 704 to get URL 705, with which she contacts Device 703 via the Internet. She gets Path 708. She follows it and ends up within scanning range of Tag 706, which is connected to Device 703. It sends URL 707 to Tag 706 in the interaction of the previous paragraph. She scans it to tell Device 703 that she is near Tag 706.

A related scenario is where Jane is at the tag in FIG. 1. She actively controls the device. She wants to leave or she has to leave. Maybe she has been there too long. She wants to return at a given later time. She wants now to reserve access for that future time. She indicates this to the device via suitable options on her web page. Jane leaves. At the future time, the device makes a time specific URL for the tag. Jane returns. She scans it. Her phone contacts the device with this URL. Because the device has already recorded her phone address from the earlier encounter, this is enough information for her to be given control again.

Or suppose that Jane remotely contacts the device over the Internet, and she is not near it. No tag scan. She wants to reserve it at a future time. The device records her phone address. When the future time arrives, the device makes a time specific URL for the tag. Jane shows up near the tag. She scans the tag with her phone. It contacts the device with the URL and the phone address. She gets access.

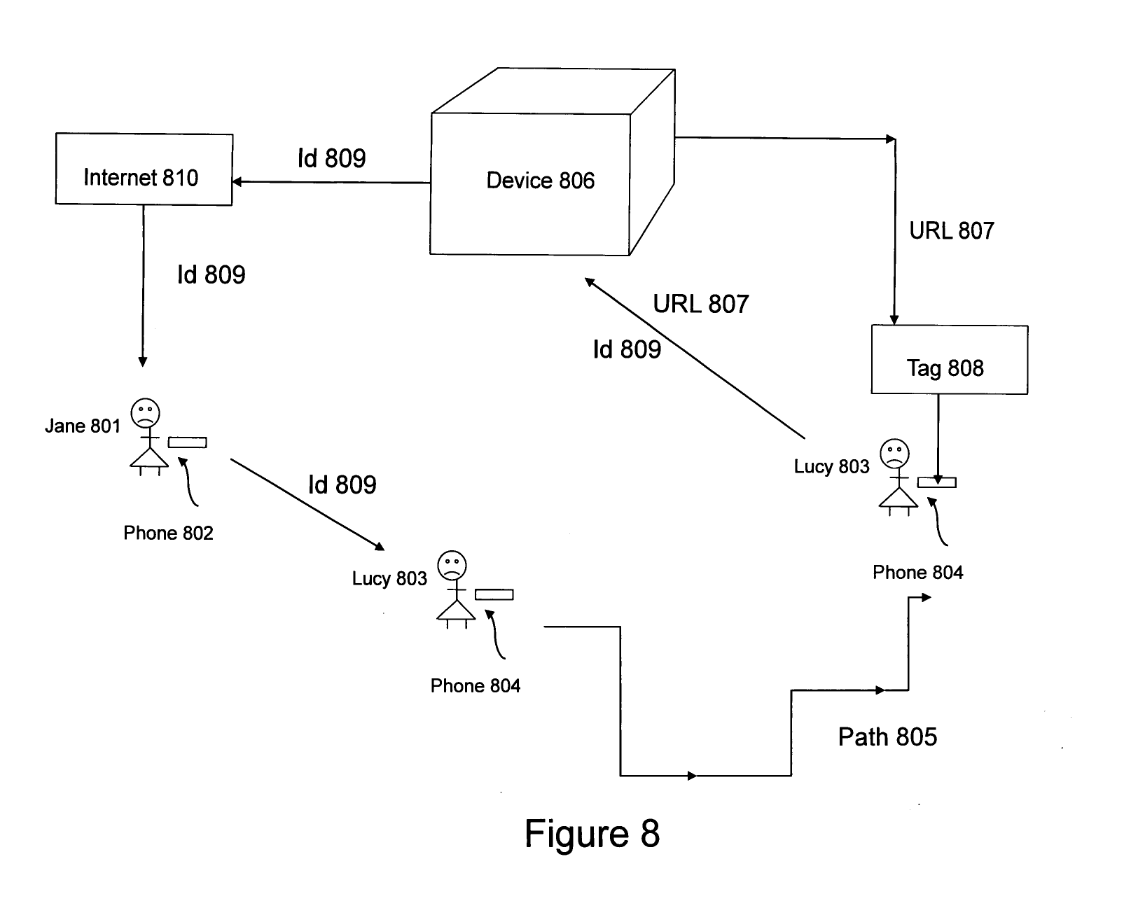

Another scenario is where Jane remotely contacts the device and she is not near it. She reserves a future use. See FIG. 8. There is Jane 801 with her Phone 802. This reservation might be transferable to others. This can be implemented by Device 806 sending Jane an Id 809 in the reservation, via Internet 810. Device 806 associates in its memory Id 809 with a future time. Jane then gives or sells the reservation to Lucy 803, who has Phone 804. This transfer can be done across the Internet. Note that the arrow from Jane 801 to Lucy 803 omits explicit mention of the Internet, for brevity.

The transfer from Jane to Lucy could be done by other means if they are near each other. One way is for Jane to encode the reservation in a barcode on her phone screen. Lucy scans it with her phone camera (assuming of course that she has one). Her phone decodes it. Or, Jane might transfer it via the Chirp method of Bergel. Or by bumping the phones, and using accelerometers in the phones, via the method by Bump Techologies.

At the future time, Lucy 803 has taken Path 805 and approaches the device's Tag 808. The device makes the time specific URL 807 for Tag 808. Lucy 803 scans the tag with Phone 804. Her phone decodes Tag 808, gets URL 807 and loads a browser with it. She gets a page from the device. It asks her to input Id 809. Which she does from the reservation. Note that in the arrow from Lucy 803 to Device 806, this communication is done via the Internet, which is omitted for brevity.

Above, when we described a user making a reservation for a given time—this might or might not be exclusive. Depending on what controls or aspects of the device are being reserved. For some interactions, only one user can do this at a time.

Above, when we discussed a device distributed over several regions, this could instead be several independent devices. Linked together in a federation or peer to peer or ad hoc grouping.

Another scenario is to look again at FIG. 1. Now suppose Device 103 can move. It might be part of a vehicle, or be entirely a vehicle. Or it might be carried by a vehicle from its current location and put at another location. At some time, Device 103 is in a location and Jane interacts with it as described in earlier sections. It can give her a map and timetable. Letting her go to a future location at a future time. At her current location, she can reserve control of the device at that future place and time. The device moves. Later, the device ascertains that a user is at its new location by making a time specific URL for the tag at that place and time. For (presumably) Jane to scan.

In this section, we assumed that issues about payment to do various actions, or of proving in a strict sense the identity of participants, can be overlaid as extra steps.

Likewise, consider the case where, for example, Jane has to go from one tag to another, as per FIG. 7. If she has a friend at the second tag, in remote communication with her, then the friend can scan the time specific tag and send her the URL, without her going to that location. Essentially, the section assumes that there is no incentive for her, financial or otherwise, to do so. She is motivated by reasons external to this submission to conform to the above rules.

7] Cellphone with a Tag;

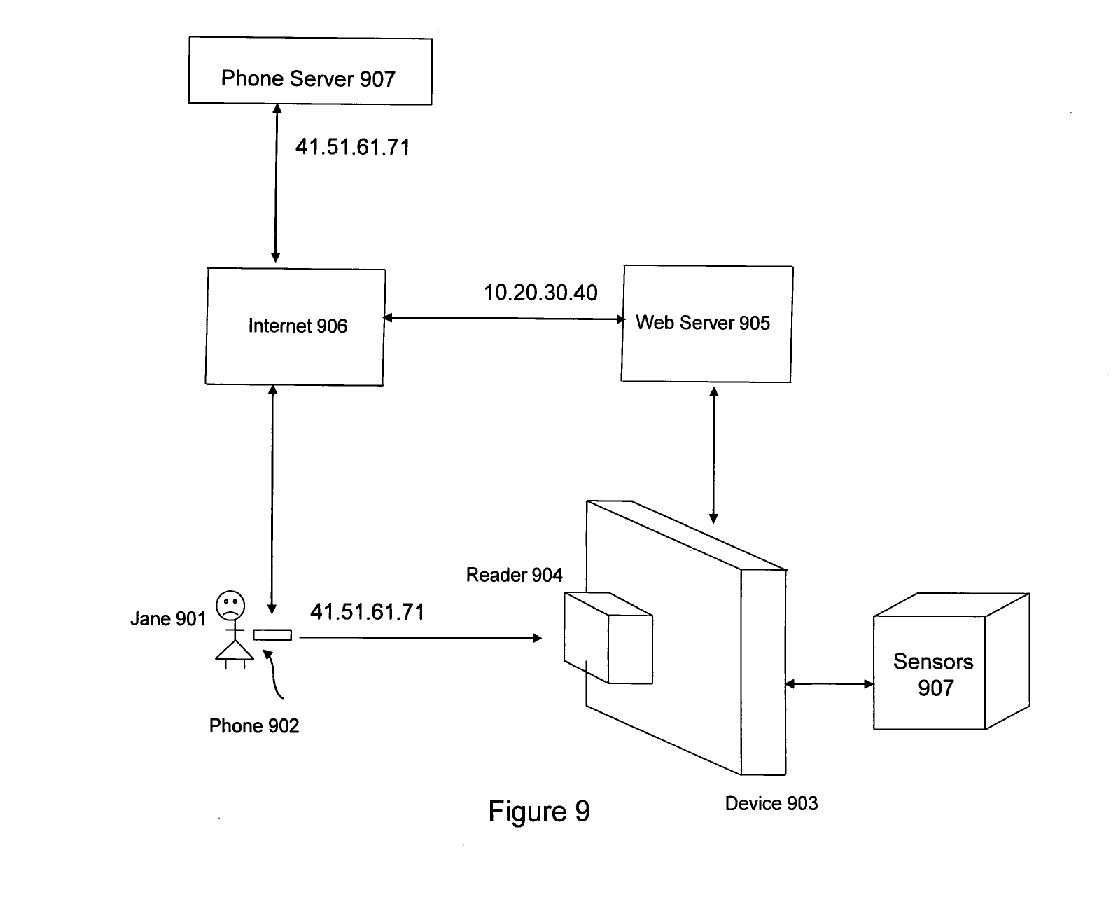

Thus far, the tag has been part of the main device, as in FIG. 1. The cellphone has been assumed to have a reader, which scans the tag on the device. The present section inverts the configuration. The cellphone now has a tag. The device has a reader. See FIG. 9. Reader 904 is part of Device 903. Here, while Reader 904 is certainly a sensor operated by Device 903, it is considered separate from Sensors 907.

Jane 901 has Phone 902. The latter has a tag which encodes an identifier of the phone. The identifier might be the phone number. Or an URL/URI. Consider the URL/URI. It could point to one of two cases. First, where the URL/URI address is a fixed domain on the Internet, with a web service that listens for queries. This fixed domain is not physically the phone. Second, where the phone has an Internet address and a web service, and the URL/URI refers to that address. In both cases, we refer to this as the phone web service. In FIG. 9, the label 41.51.61.71 refers to when the tag encodes an URL/URI. Specifically it refers to an example Internet address in that URL/URI. This is different from the other label 10.20.30.40 in FIG. 9. The latter is the Internet address of Web Server 905, which is part of Device 903.

If the tag refers to an external server, then we have the Phone Server 907. It is a standalone device on the Internet. It has the address 41.51.61.71. If the tag refers to a web server hosted on Phone 902, then Phone Server 907 should be disregarded. Below, when we refer to Phone Server 907, this is for the cases where it is a standalone machine or part of Phone 902.

Reader 904 scans the tag on the phone. The reader decodes the URL/URI. The device now knows about the phone web service. The device runs Web Server 905, as per earlier in the submission. The latter sends a string to Phone Server 907. The string is an URL referring to the device Web Server 905. Phone Server 907 gets the URL.

If the phone web service runs directly on Jane's phone, it starts a browser and loads it with the URL. Then the steps proceed as in Section 1, where the phone contacts the device phone web server and Jane interacts with the pages on her phone.

If the phone web service runs on Phone Server 907 as a separate machine on the Internet, then Phone Server 907 sends Phone 902 the URL of the device. Here, the methods for Phone Server 907 to communicate with Phone 902 are external to the submission. IPv6, for example, has methods for this scenario of mobile Internet usage. A mobile device travels and obtains temporary Internet addresses from Internet providers near it, while retaining a fixed “home” Internet address with which it communicates.

The phone then starts its browser with the URL.

What if the phone tag encodes the phone number? The reader decodes the phone number. It detects this as a phone number, because it will be in a different format than a web service. The latter might be formatted as an URL or URI. The device sends its URL to the phone number. For example, as a text message. The phone detects this and bring up its browser and loads the URL.

The method of this section is more indirect than earlier sections.

An awkward aspect of this section may be the context. Suppose the reader detects a tag and decodes it. The tag might be on an item Jane bought at a store, where the tag was not deactivated after purchase. The data on the tag could be an ISBN for a book, or a SKU (Stock Keeping Unit) for an arbitrary item. Or the tag might be on her passport. In general, a tag can be used for many purposes. Simply detecting and decoding a tag might not mean that Jane is aware of, wants or is able to do the steps in this section.

One partial answer is if the tag data is an URL or URI or phone number. This reduces the chances of the tag being on a purchased item or passport. The device might then go ahead with the steps in this submission, to send its URL to that Internet address or phone number. If the device then gets the URL sent back to it in an http query, then Jane presumably wants to interact with it in the manner described above.

8: Cost;

Another advantage of this submission is the relatively low significance of the cost of the tag, whether active or passive. Currently, the most common use of the tags has been when they are attached to items being made or sent through the supply chain. The problem is that the items might be relatively low priced or low margin. Making it prohibitive to have an expensive tag attached, where expensive might mean a price of 10 US cents or more, for example.

But in this submission, the uses are expected to be very different. The machinery or equipment or venues that the tags are attached to or controlled by are not cheap consumer items. Hence the cost of the tags might not be a significant impediment to their use.

9: Re-Scanning a Tag;

This section assumes the tag is reconfigurable.

Consider FIG. 1 again. In this submission, when Jane has scanned a tag, she typically only does this once. She then goes into an interaction with the device, using her phone. The tag was only used to initiate the interaction. In some sections, she might leave the tag and go to another tag. Or leave the tag and end the interaction and then come back later to the tag and start a new interaction.

Now suppose that Jane has need to do one or more scans of Tag 104. Why? One reason is where the second or later scans transfer sensitive data from Device 103 to Jane's Phone 102. Suppose Device 103 is owned by a financial institution. It might be a modification of an Automated Teller Machine, for example.

The tag might be the NFC variant, which is essentially using a short range type of radio frequency interaction.

The first scan of Tag 104 leads to Jane logging into Device 103. During this interaction, her phone goes through the phone carrier network, or through a local hot spot to access Device 103. She now wants to transfer some information from Device 103 to her phone. If the data goes through the wireless route, she is worried about eavesdropping across the Internet or the phone network. This data she considers more sensitive than what she has gotten or sent to Device 103 thus far.

One answer is for her to pick an option, or for Device 103 to enforce this option, where Device 103 encodes the information in Tag 104, which is assumed to be reconfigurable. Then Jane's Phone 102 rescans Tag 104 to get the information. This will not in general be an URL, like earlier in the submission.

Due to the information capacity limit in a given tag, her phone might have to scan several times. Where Device 103 might break up the data into several chunks, and encode each chunk into Tag 104. Then Phone 102 scans each Tag 104.

Also, suppose Tag 104 is an active tag. Device 103 might by default reduce the power level of the tag. To restrict its transmission range and thus reduce the chances of eavesdropping by someone near Jane. Or Jane might have an option made available on a web page sent by Device 103, to do this. The power reduction would be done before Tag 104 starts encoding and transmitting the sensitive data.

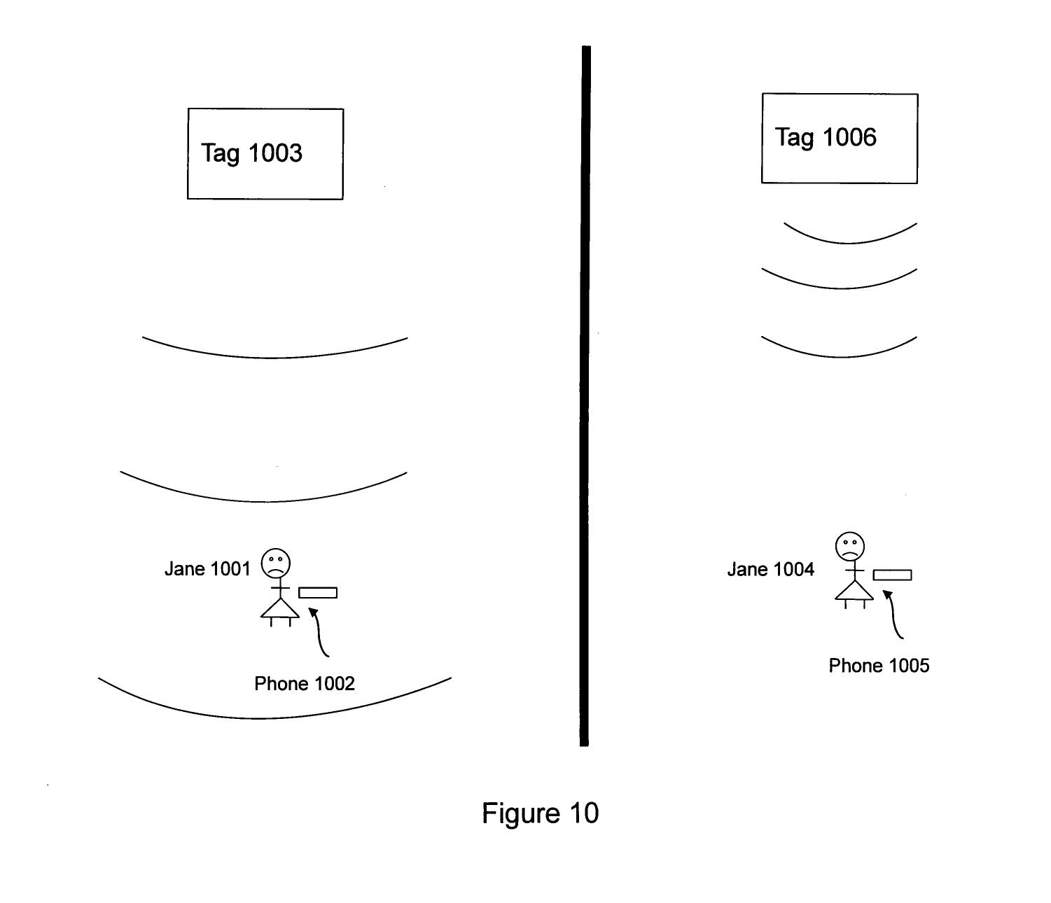

FIG. 10 shows on the left Jane 1001 with Phone 1002. She is within the transmission range of active Tag 1003. The right side of the figure shows her as Jane 1004 with Phone 1005 near Tag 1006. But now the tag has reduced its power, as suggested by the shorter transmission distance. Also, the tag has narrowed the spread of the beam. Jane 1004 is outside the beam, so she cannot detect it with Phone 1005. She must move closer. For brevity, the device controlling the tag is omitted from the figure.

The figure shows the extra feature of the device controlling the tag being able to narrow the beam. It has been possible for decades in antenna design to do this. But to the best of our knowledge, it is very uncommon or non-existent for active tags to have this ability. Due to the economics of the prevailing uses of the tags, as suggested in the previous section.

The narrowing of the beam is an optional feature. Also optional is the ability to rotate the antenna of the active tag. This is not shown in FIG. 10. The rotation might aid in restricting the area in which Jane can stand, when sensitive data is transferred via the tag.

Thus in one implementation we have these variables for an active tag. The power level, which controls the overall transmission distance. The beam spread, which might be (approximately) characterised by a single variable like the angular width of the beam. The beam orientation, which might be defined by two angles—azimuth and elevation of the center of the beam.

A radio engineer skilled in that field will understand that more complex characterisations are possible for radio beams. With concomitant more variables.

In FIG. 10, on the right side, Jane can still use her phone to communicate wirelessly with the device. In general, if she is outside the beam, the web page on her phone will or should advise her to move closer.

Prior to the interaction, when the tag is installed, the person doing so might also do calibration steps. To find the closest distance that a person like Jane can come to the tag. Optionally, if the beam spread or orientation can be altered, he could also find possible minimal values. The web pages that appear on Jane's phone can advise her using these values, on how close she should approach. Of course, empirically, the simplest way could be for her to just come as close to the tag as she can.

Another method might be possible. The device controlling the tag puts a page on the phone. Jane walks as close to the tag as possible. The page has options that alter the tag power. She uses these to lower the power just until her phone can no longer detect the tag. Then she raises the power to the minimum necessary for her phone to detect.

In our US patent “3” [“Transmitting and receiving data via barcodes through a cellphone for privacy and anonymity”], we described a related use. There, instead of an active tag, a barcode on an electronic screen was used. Where the user would scan it with her phone.

There are similarities and differences between “3” and the current submission.

The similarities are mostly in the motivations for why Jane might use either.

The biggest difference is that that a barcode is scanned via a direct line of sight between the phone and the barcode. Hard for someone else to also scan it, if she is close to the screen. But the tag emits a radio signal that is not line of sight. So in this submission, it is far more important for restrict the range of the beam when the sensitive data is transmitted. And of all the ways this can be done, lowering the power level is the most important. Whereas in “3”, the analogous step would have been to lower the intensity of the light coming from the display screen. But given the context of use, this was seen as unnecessary.

Thus far, this section assumed that the tag is active. Suppose it is passive. Then the discussion about power levels is moot. Though the discussion about the beam spread or orientation could still be germane. If the necessary hardware aspects of the antenna of the tag can be manipulated by the device.

10: Turning on a Tag;

Jane is near a tag. But her phone cannot detect it. Assume that the tag is active but is turned off or has a low power level. How can Jane turn it on?

Suppose her phone has knows its coordinates. For example, via GPS if she is outdoors. Suppose Jane finds the device of FIG. 1 on the Internet. Perhaps she has bookmarked its address from an earlier use. Or perhaps the device is getting data from another “parent” controlling server which is at an Internet address or domain already known to Jane. In either case, the phone transmits its coordinates to the server or ultimately the device.

The device then turns on the tag or turns up its power.

There can be an interactive loop where the device increments the power to the tag in steps. Jane tries at each step to scan the tag. If unsuccessful, she indicates so on a page furnished to the phone by the device. The device then steps up the power. Until presumably Jane's phone detects the tag. Then the iteration stops.

Suppose the device controls several tags. It might do the above with the tag closest to Jane, if it knows her location to sufficient accuracy to do so. If not, it could repeat the above steps with each tag. Stopping once Jane can detect a tag.

If in either of the last 2 paragraphs, Jane cannot detect the tag, the device might send her a page advising her to move. Perhaps offering suggestions of where to move to. The device might use prior knowledge of the geometry of its surroundings and the location of its tag. To perhaps describe the surroundings and suggest how Jane can get close to the tag.

A related idea is where Jane gets a reservation for a future time and place, as discussed in an earlier section. She (or someone she transfers the reservation to) goes to that place at that future time. But the tag is turned off. She contacts the device on the Internet, giving her phone location. The device finds the closest tag and turns it on, so that she can scan it.

11: Using an App on a Cellphone;

The earlier sections all involved Jane's phone using a phone browser. An alternative is where the phone has an “app”, possibly running in native mode. One way is for the app for has the prefix of the URL of the device. Suppose the device has the domain alpha.com. The prefix might be “http://alpha.com”. When the phone scans a tag, the tag would only need to supply the suffix—the rest of the URL. This reduces the data requirements on the tag.

The app would then join the prefix and the suffix to form a complete URL, which it then uses to access the device server.

Note in this case that the server need not return data in the format of a web page. Instead of a browser on the phone that shows the data, as HTML as in earlier sections, the app could get data in some pre-defined format and then display it.

But we suggest that as a practical matter, that the data be formatted as HTML, so that the app effectively acts as a custom browser. This lets the programmers coding the interaction to use widespread knowledge of HTML. In this event, the scenario of this section largely reverts back to the situations of the earlier sections, where a browser was used on the phone.

12: Minimising Energy Consumption on a Mobile Device;

As before, we will take the mobile device to be a cellphone. Thus far, we have not considered how Jane can minimise energy consumption on her phone. A rough rule of thumb is that the energy cost of transmitting or receiving wirelessly a bit can be 2 orders of magnitude more expensive than a purely mathematical manipulation of that bit on the phone. (The latter assumes no special use of the phone's screen or speaker, as those can significantly drain power.) Hence, reducing unnecessary wireless transmissions is important.

We assume that the tag in FIG. 1 is reconfigurable.

The key idea in this section is that the format of the URL in the tag is known to the phone. By this we mean preferably known to software already present on the phone. Device 103 encodes information in the URL to be used by the phone to decide whether to make a wireless query to the device with the URL. The energy saving comes from the phone and Jane being occasionally able to decide NOT to make that wireless query. This decision might be made purely by the phone or by a combination of the phone and Jane. In contrast, in earlier sections, once the phone decoded the URL, it would always make that query. Which was an expensive energy process.

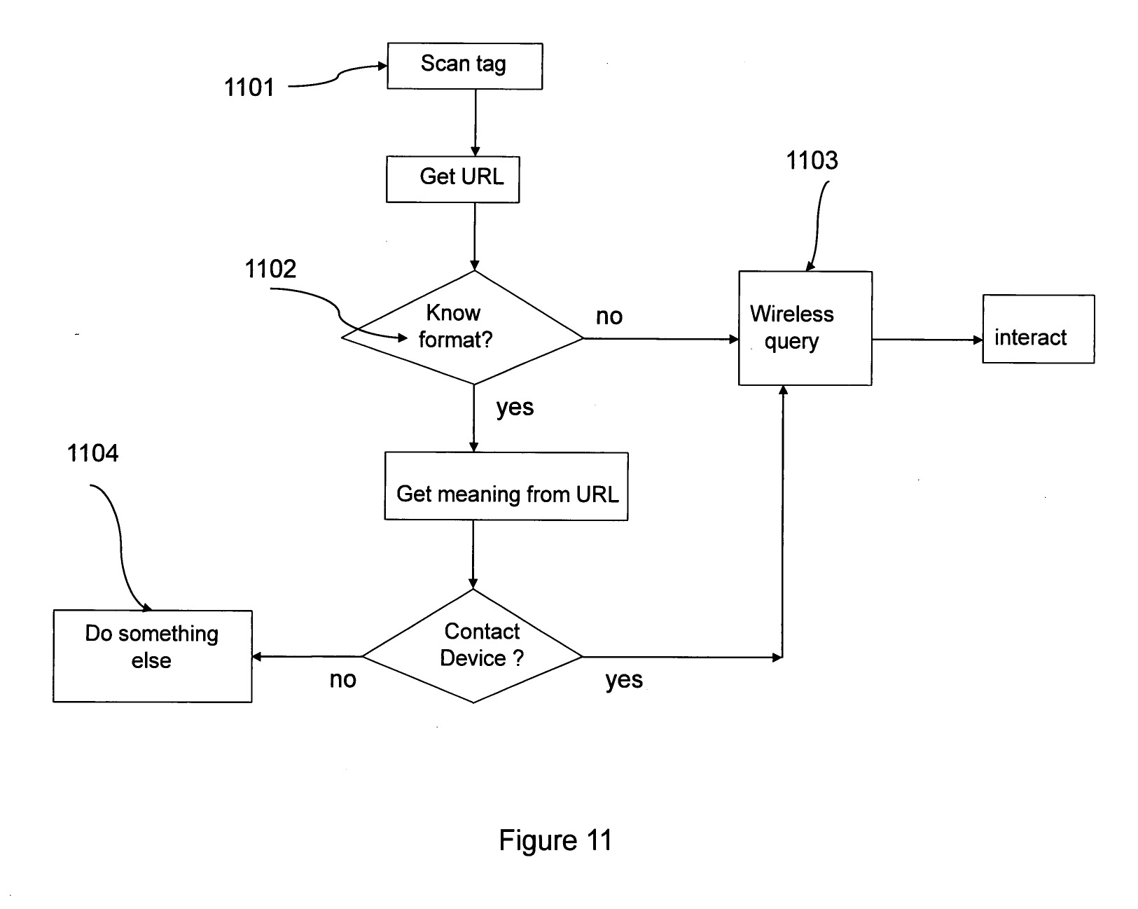

See FIG. 11. It is a flow chart of actions done on the phone. It starts at item 1101, where the phone scans the tag. The phone decodes the URL. Earlier, we discussed possible variables and their values in the right hand part of the URL, after the domain. Item 1102 is a branch that depends on the phone knowing the format of the URL. The phone can contain a simple database or table that maps from a domain to the format of an URL referring to that domain. If the domain of the decoded URL is not in the table, then the branch ‘no’ is taken to item 1103. This does the usual wireless query by the phone, where it loads a browser with the URL and contacts the domain with the browser. After which, an interaction occurs between the phone and the domain.

Earlier in the submission, this ‘no’ branch was the only choice. Now consider a simple example of known formatting. Assume the scenario of Section 2 on active and passive users near a tag. Suppose the URL has a label ‘a’, with a value. When a value is greater than or equal to 0, it means the number of active users. If the value is ‘f’, then the maximum number of such users has been reached. Suppose also that the URL has a label ‘q’. When its value is greater than or equal to zero, it means the number of passive users in the queue. If the value is T then the queue is full and no other users will be put into it.

Now suppose the phone decodes the URL and sees ‘a=f’. It uses its database to convert this to telling Jane that the limit of active users has been reached. It can do this via any means available on the user interface of the phone. She only wants to be an active user. She does not want to wait around as a passive user in the queue. Jane decides not to contact the device. Hence in FIG. 11, we reached Item 1104.

A variant is where at some earlier time, Jane has set a default so that when the phone detects this limit of no more active users, it does not ask Jane. Which is less manual intervention by her and also less energy expenditure by the phone. It does not have to pop up a window on its screen or beep or somehow otherwise ask Jane.

Suppose the URL has ‘a=f&q=4’. This means no more active users, but someone else can be added to the queue of passive users. If Jane is willing to be a passive user, then she tells the phone to make the wireless query of 1103.

A variant is where at some earlier Jane, Jane has set a default so that the phone does this automatically without asking her.

Suppose the URL has ‘a=f&q=f’. This means no more active or passive users. In this case, Jane will not wait around. She tells the phone not to make a wireless query, in 1104.

A variant is where at some earlier Jane, Jane has set a default so that the phone does this automatically without asking her.

Another example is where a label and its value indicates the estimated time to wait. This could be the time that a person added to the end of the queue has to wait to become an active user. Or when the queue is full, the estimate is of the time needed till when the queue can accept other users. The value is that the phone and Jane can decide if she wants to wait around. If she will not wait, then the phone will not make the wireless query with the URL.

Above, we wrote about the phone knowing the format of the URL to the right of the domain. More precisely, it only has to know the format of the labels germane to this section. If when parsing the URL it meets a label unknown to it, the phone can just skip that label and also skip its value, if the label has a value.

Another type of formatting of the URL can happen using subdomains. Suppose instead of the URL having a domain written as a raw Internet address, it uses a domain name, like “where.com”. There could be subdomains written, with meanings already known to the phone. For example, suppose an URL had the domain a-3.where.com. The subdomain “a-3” might mean that there are 3 active users and that another active user could be added. Hence the phone might make the wireless query of 1103.

But if the URL had the domain a-f.q-4.where.com, this could mean that the maximum number of active users is present (“a-f” means “active is full”), and the queue has 4 passive users and another user could be added to the queue. The phone can tell Jane. If she needs to be an active user now, then she tells the phone not to make the wireless query. But if she is willing to wait in the queue, then the phone makes the 1103 query.

Note in passing that in the examples of subdomains, one implementation is that all the examples could map to the same raw Internet address as the base domain, where.com. There is no need to explicitly list every subdomain with the ISP or Network Service Provider for Device 103. Just a default policy. Essentially, the subdomains only “exist” on the client browser side, for the use of the phone program as described above.

Another possibility is to encode meaning in the port number of the URL. For example, an URL like http://10.20.30.40:1511 could be used. The non-standard 1511 port has the meaning that the maximum number of active users has been reached, but more users could be added to the queue of passive users. And perhaps port 1512 means that the queue is full. So a phone that parses the port numbers and knows the meanings can tell Jane or automatically act on these itself.

If port numbers are used, it is understood that Web Server 105, which gets these URLs, will be able to accept all non-standard port queries. So any firewall that is part of Web Server 105, or between it and the Internet, will admit those queries.

Above, we described 3 cases of how to format an URL for energy minimisation by the user mobile device. Using the right side of the URL, after the domain. Using subdomains. Using port numbers. Any 2 of these cases, or all 3, could be combined.

It is the reaching of and the doing of 1104 instead of doing 1103 that is the point of FIG. 11 and this section.

The program on the phone that implements the above might be considered to be an ‘app’.

The above idea can also be applied to other ways that the phone can get an URL. Like when the URL is found from an audio signal like a “Chirp”. Or, as in our patent “1”, when the URL is encoded in a barcode shown on an electronic screen.

We claim:

1. A system of a device with a tag, where the device is connected to the Internet; where the device runs a server; where the tag encodes an Universal Resource Locator (URL) with an Internet address of the device; where a user with a mobile device scans and decodes the tag; where the mobile device starts a browser with the URL; where the server sends a page to the mobile device; where the page can cause a macroscopic change in the device or its surroundings; where the page can display data from the device.

2. The system of claim 1, where the device permits a maximum number of simultaneous active users; where if this is exceeded, extra users are put into a queue; where, when an active user is logged out, a user in the queue is given active control.

3. The system of claim 2, where the tag is active; where the queue has a maximum length; where if the queue reaches this length, the tag is deactivated.

4. The system of claim 3, where when the queue length falls below a maximum length, the tag is reactivated.

5. The system of claim 1, where the tag is active; where the user can deactivate the tag; where the user can reactivate the tag.

6. The system of claim 1, where the tag is active; where the user can adjust a power transmission setting of the tag.

7. The system of claim 1, where the user has exclusive control of some parameters of the device; where a second user scans the tag; where the second user gets exclusive control of other parameters of the device.

8. The system of claim 1, where the tag is active; where the device permits a maximum number of simultaneous active users; where if this is exceeded, the tag is deactivated.

9. The system of claim 1, where the user can let other users get read only copies of pages or audio sent to her mobile device from the server.

10. The system of claim 9, where the user can specify a maximum number of other users to get data from her.

11. The system of claim 9, where the device makes a list of such active users; where a later user scans the tag; where the later user gets the list; where the later user picks a user; where the later user gets read only copies or audio of pages sent to the user.

12. A system of a first device on the Internet, running a web server; a second device with an RFID tag, where the second device is connected to the Internet; where the tag encodes an Universal Resource Locator (URL) with an Internet address of the first device; where the first device sends commands to the second device; where the second device does the commands; where the second device sends data to the first device; where a user with a mobile device scans the tag; where the mobile device starts a browser with the URL; where the server sends a web page; where the web page can control the first device or display data from the first device.

13. The system of claim 1, where the device has a speaker; where the speaker emits an audio encoding an identifier of the URL; where the user records the audio on her mobile device; where the mobile device decodes the audio; where the mobile device starts a browser with the URL; where the server sends a web page; where the web page can control the device or display data from the device.

14. The system of claim 13, where the speaker is turned off; where the user scans the tag; where the user turns on the speaker.

15. The system of claim 1, where there are multiple tags; where a scanning of a tag gives a page controlling a specific set of controls of the device.

16. The system of claim 13, where there are multiple speakers emitting audio; where the decoding of an audio gives a page controlling a specific set of controls of the device.

17. The system of claim 16, where there are multiple tags.

18. The system of claim 1, where the URL varies as a function of time; where if the server gets an URL that is not currently encoded in the tag, the server sends a different page than when the server gets an URL that is currently encoded in the tag.

19. The system of claim 18, where a user gets a reservation for a future time; where at that time, the user scans the tag; where the user sends the URL decoded from the tag and the reservation to the device; where the device verifies the data; where the device gives the user access to controls of the device

20. The system of claim 2, where a/the format of the URL is known to the mobile device; where the URL encodes information about one or more of a) an availability of active control; b) whether the user can be put into the queue; c) an estimate of a time to wait if active control is not available; d) an estimate of a time to wait if the user cannot be put into the queue; where the mobile device parses the URL; where the mobile device decides to make a query or not make a query to the server.
